(19) United States
(12) Patent Application Publication
(10) Pub. No.: US 2007/0044226 A1
(43) Pub. Date: Mar. 1, 2007

(54) Apparatus for causing milk-like bubbles to be contained in fluid

(76) Inventors: Yang-Yuan Yeh, Taipei City (TW); Fu-Ching Tseng, Taipei (TW); Kuo-Kuei Tseng, Taipei (TW)

Correspondence Address: BRUCE H. TROXELL, SUITE 1404, 5205 LEESBURG PIKE, FALLS CHURCH, VA, 22041, US

(21) Appl. No.: 11/281,725

(22) Filed: Nov. 18, 2005

(30) Foreign Application Priority Data
Aug. 30, 2005 (TW) 094214959

(51) Int. Cl. A61H 33/06

(52) U.S. Cl. 4/541.5

(57) ABSTRACT

An apparatus for causing milk-like bubbles to be contained in fluid comprises an inlet and outlet of a high-pressure pump respectively combined with an input pipe and a connecting pipe; the input pipe is combined with an air entering pipe; the connecting pipe is combined with a high-pressure groove; the high-pressure groove is further combined with an output pipe; an input hole of the input pipe is larger than an output hole of the output pipe to allow the flow of fluid entering high-pressure pump to be larger than the flow of fluid expelled out of the output pipe, air is drawn into a fin set of the high-pressure pump through the air entering pipe to mix with the fluid and is quickly stirred to form tiny bubbles, and then delivered to the high-pressure groove to store there, the bubbles are finer owing to a higher hydraulic pressure; the fluid with the tiny bubbles is expelled from the output pipe.

### BACKGROUND OF THE INVENTION

1. Field of the Invention

The present invention relates to a bubbles generating apparatus, and more particularly to an apparatus capable of generating tiny bubbles.

2. Description of Related Art

Causing a great amount of tiny bubbles to be mixed into water in a bathtub can increase oxygen quantity contained in the water and allow the water to be milk-like colored; it is of more novelty sense. Is A great amount of apparatuses capable of generating tiny bubbles are disclosed in the patents such as Taiwan Patent No. 499,533 entitled as “supper tiny bubbles generating apparatus” and Taiwan Patent No. 268,034 entitled as “water curing machine”. Among these, Taiwan Patent No. 286,034 discloses that a pressurization device is connected with a storage device through a pressurizing pipe. The storage device has a flow circulating pipe and output pipe. Another end of the circulating pipe is connected with an input pipe and an air inlet and bubble mixing pipe are installed on the circulating pipe. The pressurization device can pressurize water enters therein and then deliver it into the storage device through the pressurizing pipe. Furthermore, the water entering the storage device flows into the bubble mixing pipe through the circulating pipe to mix with air enters the air inlet to yield Venturi effect to form fine bubbles like milk.

The structures of tiny bubble generating device disclosed in the patents mentioned above are very complex and the inner structures thereof are not currently available in the market; they need be extraordinarily be designed, manufactured so that the production cost is increased. In addition, the entire volume thereof is very large and not able to be installed at the bottom plate of the current market available bathtub; it needs a larger space to install them. This causes the trouble in combining them with the bathtub.

### SUMMARY OF THE INVENTION

For providing a simply structured, more production cost saving and smaller volume tiny bubbles generating apparatus, the present invention is proposed.

The main object of the present invention is to provide an apparatus for causing milk-like bubbles contained in a fluid, having a simpler structure, saving the more production cost and elevating the product competitiveness ability.

Another objective of the present invention is to provide an apparatus for causing milk-like bubbles, having a smaller volume, capable of being installed under the bottom of a current bathtub, occupying smaller space and capable of being matched up with the current bathtub.

Still another objective of the present invention is to provide an apparatus for causing milk-like bubbles, capable of increasing the temperature of water while generating tiny bubbles and having an effect on keeping the temperature of water in a bathtub constant.

### BRIEF DESCRIPTION OF THE DRAWINGS

The present invention can be more fully understood by reference to the following description and accompanying drawings, in which:

FIG. 1 is a perspective view, showing an apparatus for causing milk-like bubbles contained in a fluid of a first preferred embodiment according to the present invention;

FIG. 2 is a schematic view, showing an apparatus for causing milk-like bubbles contained in a fluid of a second preferred embodiment according to the present invention;

FIG. 3 is a schematic view, showing a combination of a high-pressure groove and an output pipe of a second preferred embodiment according to the present invention;

FIG. 4 is a schematic view, showing an apparatus for causing milk-like bubbles contained in a fluid of a third preferred embodiment according to the present invention;

FIG. 5 is a schematic view, showing a combination of a high-pressure groove and an output pipe of a third preferred embodiment according to the present invention;

FIG. 6 is a schematic view, showing that an apparatus for causing milk-like bubbles contained in a fluid is stalled outside of a bathtub according to a first preferred embodiment of the present invention; and

FIG. 7 is a schematic view, showing that an apparatus for causing milk-like bubbles contained in a fluid is stalled outside of a bathtub according to a second preferred embodiment of the present invention.

### DETAILED DESCRIPTION OF THE PREFERRED EMBODIMENTS

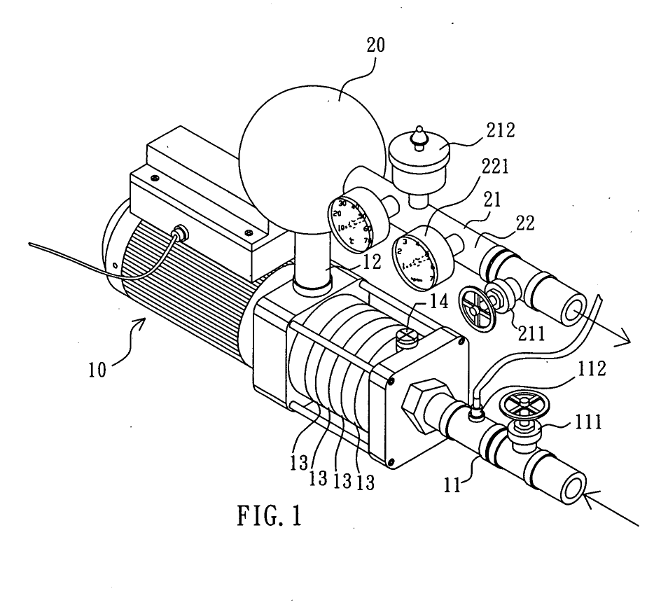

Please refer to FIG. 1. An apparatus for causing milk-like bubbles to be contained in a fluid of a first preferred embodiment according to the present invention comprises a high-pressure pump 10. An inlet and outlet of the high-pressure pump 10 are respectively combined with an input pipe 11 and a connecting pipe 12; the high-pressure pump 10 has at least one fin set 13. An exhaust hole is disposed at the top end of the high-pressure pump 10 close to the inlet thereof; the exhaust hole is airtightly sealed by a screw 14 ordinarily. The input pipe 11 is combined with a throttle valve 111 and inhaling pipe 112. The inhaling pipe 112 is installed between the high-pressure pump 10 and the throttle valve 111. The connecting pipe 12 is combined with a high-pressure groove 20. The high-pressure groove 20 is further combined with an output pipe 21 and a connecting pipe 22. The output pipe 21 is combined with a throttle valve 211 and an exhaust valve 212. The exhaust valve 212 is installed between the high-pressure groove 20 and the throttle valve 211. Another end of the connecting pipe 22 is combined with a hydraulic pressure gauge 221.

When the high-pressure pump 10 is actuated, fluid is inhaled from the input pipe 11 and drained from the output pipe 21. The throttle valve 111 and 211 are respectively used to control the dimensions of the diameters of the inlet of the input pipe 11 and the outlet of the output pipe 21 so as to control the flows of fluid inhaled into the high-pressure pump 10 and drained out of the output pipe 21. When the flow of the fluid inhaled into the high-pressure pump 10 is larger than the flow thereof drained out of the output pipe 21, a great amount of fluid not drained out immediately can then be stored in the high-pressure groove 20 so that the high-pressure groove 20 has a higher hydraulic pressure. The hydraulic pressure gauge 221 can be used to show the hydraulic pressure in the high-pressure groove 20. Air is inhaled into the fin set 13 of the high-pressure pump 10 through the inhaling pipe 112 to mix with the fluid, and delivered to the high-pressure groove 20 to store after it is quickly stirred to form tiny bubbles, the bubbles are caused to be finer by means of the higher hydraulic pressure, and the content thereof in the fluid is elevated. Finally, the fluid with bubbles is drained out from the output pipe 21.

More fins in the fin set 13 can allow the bubbles to be stirred through them to become finer. Besides, the input pipe 11 and the output pipe 21 can respectively have a fixed inlet and outlet; the diameter of the inlet is larger than the one of the outlet, it can attain to the effect causing the flow of the fluid entering the high-pressure pump 10 to be larger than the one drained out of the outlet 21.

In the process of the revolution of the high-pressure pump 10, because the tiny bubbles collide with and strike against fluid such as water particles incessantly, the temperature of the water can further increased; the water drained to another container such as a bathtub through an output pipe has a higher temperature so that the temperature of the water stored in the bathtub can be increased. This allows the water in the bathtub to be able to be kept warmth.

When the revolution of the high-pressure pump 10 is stopped, the air remained in the high-pressure pump 20 is expelled by means of the exhaust valve 212 to allow the apparatus to be more smoothly running at the next time.

The merit of the present invention is that the apparatus according to the present invention can be constituted by market-available and ready-made components such as the high-pressure pump 10, the throttle valves 111 and 211, the high-pressure groove 20 and the exhaust valve 212; it doesn't need to be designed and no special components need to be manufactured. Therefore, the production cost can be broadly saved so that the product competitiveness can be enhanced. Besides, components with a smaller volume can be chosen to use so as to be assembled to be an apparatus with a smaller volume. The apparatus can be installed below the bottom of the bathtub; space outside of the bathtub doesn't need to be occupied much so that it is convenient to use a ready-made bathtub coordinately.

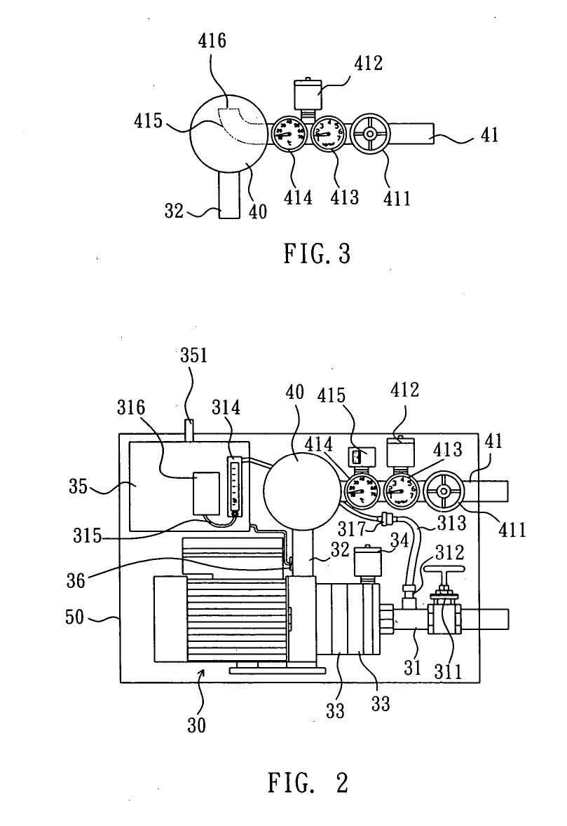

Please refer to FIG. 2. An apparatus of a second preferred embodiment according to the present invention same as the apparatus of the first embodiment according to the present invention shown in FIG. 1, also has a high-pressure pump 30, input pipe 31 and connecting pipe 32, in which the high-pressure pump 30 has at least one fin set 33. The input pipe 31 is combined with a throttle valve 311 and air entering pipe 312. The connecting pipe 32 is combined with a high-pressure groove 40. The high-pressure groove 40 is combined with output pipe 41. The output pipe 41 is combined with a throttle valve 411 and exhaust valve 412. But, in the second embodiment, the air entering pip 312 is further connected to a connecting pipe 313, another end of the connecting pipe 313 is connected to an air flow meter 314, the air flow meter 314 is further connected to one end of a connecting pipe 315 and another end of the connecting pipe 315 is connected to a air pump 316. An exhaust hole of the high-pressure pump 30 is combined with an exhaust valve 34. The output pipe 41 is further combined with a hydraulic pressure gage 413, thermometer 414 and a hydraulic pressure switch 415; the high-pressure pump 30 is electrically connected to an automatic controller 35. The automatic controller 35 has a controlling element 351. The controlling element 351 is an element such as a key or knob for a user to operate the automatic controller 35. The air flow meter 314, the connecting pipe 315 and the air pump 316 are all accommodated in the automatic controller 35. The connecting pipe 32 is combined with a high-temperature protecting switch 36. The hydraulic pressure switch 415 and the high-temperature protecting switch 36 are respectively electrically connected to the automatic controller 35. The connecting pipe 315 is further separated to two sections; the sections are respectively combined with two ends of a check valve 317. Furthermore, all components are covered by a housing 50 except the controlling element 351 of the automatic controller 35.

The second embodiment uses the air flow meter 314 to display an air flow entering the high-pressure pump 30, the check valve 317 to prevent the flow from flowing back to the air flow meter 314 and the air pump 316 to cause damage, the thermometer 414 to display the temperature of the flow, the exhaust valve 34 to expel the air remaining in the high-pressure pump 30 when the revolution of the high-pressure pump 30 is stopped, the automatic controller 35 to control the running time of the high-pressure valve 34 and the air pump 316 to control the flow rate of the air entering the air entering pipe 312. When the temperature of the fluid is too high or the temperature is increased owing to the idle running of the high-pressure pump 30, the automatic controller 35 detects high hydraulic pressure message output from the high-temperature protecting switch 36, and then controls the high-pressure pump 30 to stop running; the high-pressure pump 30 is revolved again after the temperature is lowered. When the fluid is stopped entering the input pipe 31 such that the idle running of the high-pressure pump 30 is caused, the automatic controller 35 detects low hydraulic pressure message output from the hydraulic pressure switch 415, and then controls the high-pressure pump 30 to stop running; the high-pressure pump 30 is revolved again after a period of preset time to prevent it from being idle running.

Please refer to FIG. 3. The high-pressure pump 40 of the second embodiment according to the present invention is formed to be spherical shaped. An inlet end 415 of the output pipe 41 extended into the inner part of the high-pressure groove 40 is bent upward, an opening thereof faces upward and is close to the top end of the high-pressure groove 40 to allow the tiny bubbles gathered at the top end of the high-pressure groove 40 to be expelled easily.

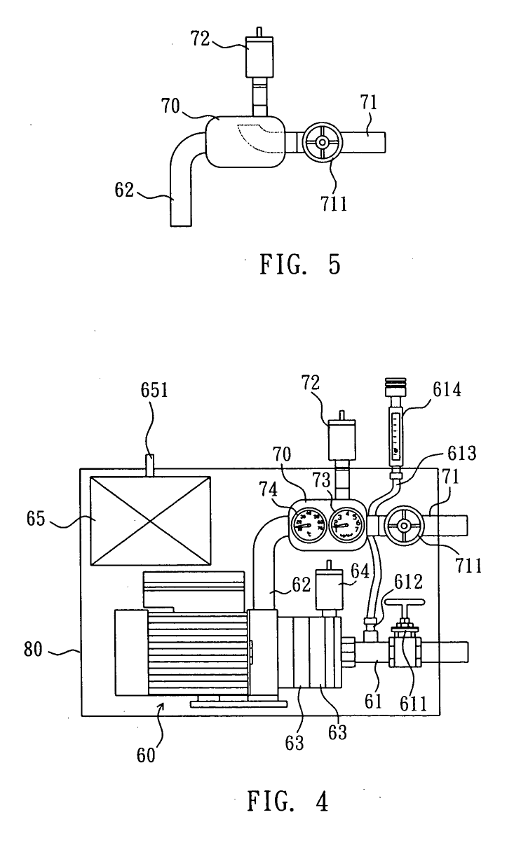

Please refer to FIG. 4. An apparatus of a third preferred embodiment according to the present invention approximately same as the apparatus of the second embodiment according to the present invention shown in FIG. 2, also has a high-pressure pump 60, input pipe 61 and connecting pipe 62, in which the high-pressure pump 60 has at least one fin set 63. An exhaust hole of the high-pressure pump 60 is combined with an exhaust valve 64. The high-pressure pump 60 is electrically connected to an automatic controller 65. The input pipe 61 is combined with a throttle valve 611 and air entering pipe 612. The connecting pipe 62 is combined with the high-pressure groove 70. The high-pressure groove 70 is combined with an output pipe 71. The output pipe is combined with the throttle valve 711. The air entering pipe 612 is further connected to a connecting pipe 613 and another end of the connecting pipe 613 is connected to an air flow meter 614. All components are all covered by a housing 80 except the air flow meter 614, an exhaust valve 72 and a controlling element 651 of the automatic controller 65. But, in the third embodiment, the high-pressure groove 70 is connected with the exhaust valve 72, a hydraulic pressure meter 73 and a thermometer 74.

Please refer to FIG. 5. A high-pressure groove 70 of a third preferred embodiment of the present invention is formed to be a rectangular parallelepiped. An inlet end of the output pipe 71 extended into the inner part of the high-pressure groove 70 is bent upward, an opening thereof faces upward and is close to the top end of the high-pressure groove 70 to allow the tiny bubbles gathered at the top end of the high-pressure groove 70 to be expelled easily.

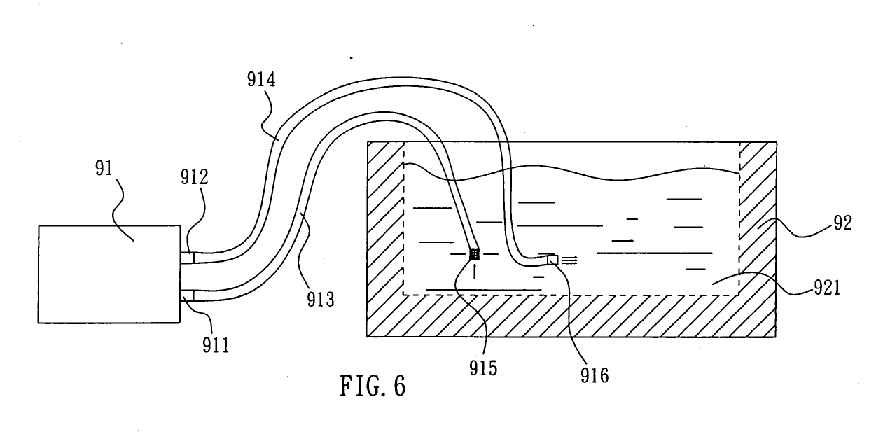

Please refer to FIG. 6. A first use manner that an apparatus 91 according to the present invention is installed outside of a bathtub 92 is that an input pipe 911 and output pipe 912 are respectively connected with a water drawing-in head 915 and a nozzle 916 through connecting pipes 913 and 914. The water drawing head 915 and the nozzle 916 are all placed in the bathtub 92. The water 921 in the bathtub 92 is guided into the apparatus 91 by the water drawing-in head 951 and water with milk-like bubbles is sprayed out from the nozzle 916.

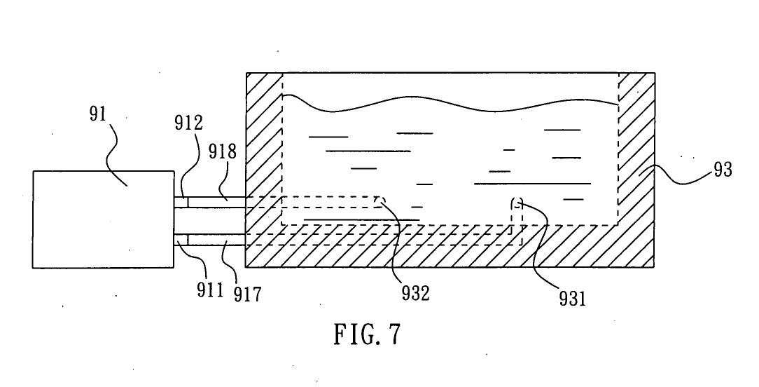

Please refer FIG. 7. A second use manner that the apparatus 91 according to the present invention is installed outside of the bathtub 93 is that the wall of the bathtub 93 is combined with the water drawing-in head 931 and the nozzle 932. Furthermore, the input pipe 911 and the output pipe 912 of the apparatus 91 are respectively connected to a water drawing-in head 931 and a nozzle 932 through connecting pipes 917 and 918. The water in the bathtub 93 can be guided into the apparatus 91 by the water drawing-in head 931, and the water with milk-like bubbles can be sprayed out through the nozzle 932.

A door allowing a user to open to process the adjustment of the component such as the throttle valve is disposed on each of the housings of the second and third embodiments according to the present invention. The door has a panel made from a transparent material to allow the user to see values displayed on a hydraulic pressure meter, thermometer, air flow gage and etc. Such kind of housing is usual; it is not shown in the figures.

Each of the embodiments according to the present invention mentioned above all can save the cost, enhance the product competitiveness. Moreover, the apparatus can be installed at the bottom of a general bathtub; it is convenient to be matched up with a ready-made bathtub. Besides, the temperature of the water stored in the bathtub can be increase so that it has an effect keeping the warmth of the water in the bathtub.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents. What is claimed is:

1. An apparatus for causing milk-like bubbles to be contained in a fluid, comprising an inlet and outlet of a high-pressure pump respectively combined with an input pipe and connecting pipe; said high-pressure pump having at least one fin set; said input pipe being combined with an air entering pipe; said air entering pipe being installed between said high-pressure pump and an input hole of said input pipe; said connecting pipe being combined with a high-pressure groove; said high-pressure groove being further combined with an output pipe; said input hole of said input pipe is lager of an output of said output pipe such that the flow of the fluid entering said high-pressure pump is larger than the one expelled out of said output pipe, air being drawn into said fin set of said high-pressure pump through said air entering pipe to mix with said fluid, and being quickly stirred to form tiny bubbles and then delivered to said high pressure groove to store; said bubbles being finer owing to higher hydraulic pressure; said fluid with said tiny bubble being expelled from said output pipe.

2. The apparatus according to claim 1, wherein said input pipe is combined with a throttle valve; said output pipe is further combined with a throttle valve; whereby, said throttles are utilized to respectively control dimensions of the diameters of said output hole and said output hole of said output pipe.

3. The apparatus according to claim 1, wherein an inlet end of said output pipe extended into the inside part of said high-pressure groove is curved upward, and an opening of said inlet end faces upward and is close to a top end of said high-pressure groove; whereby, said tiny bubbles gathered at said top end of said high-pressure groove is easily expelled.

4. The apparatus according to claim 2, wherein said air entering pipe is further connected with a connecting pipe, another end of said connecting pipe is further connected with an airflow gauge; another connecting pipe is connected between said air flow gauge and an air pump; whereby, said air pump is utilized to output air and said air flow gauge is utilized to display air flow flowing into said high-pressure pump.

5. The apparatus according to claim 4, wherein one of said high-pressure groove and said output pipe between said high-pressure groove and said another throttle valve is combined with a hydraulic pressure meter; whereby, said hydraulic pressure meter is utilized to display hydraulic pressure in said high-pressure groove.

6. The apparatus according to claim 5, wherein said high-pressure groove and said output pipe between said high-pressure groove and said another throttle valve is combined with exhaust valve; whereby, when the revolution of said high-pressure pump is stopped, said exhaust valve is utilized to expel the air remained in said high pressure groove.

7. The apparatus according to claim 6, wherein an exhaust hole of said high-pressure pump is combined with an exhaust valve; whereby, when the revolution of said high-pressure pump is stopped, said another exhaust valve is utilized to expel the air remained in said high-pressure pump.

8. The apparatus according to claim 7, wherein said connecting pipe connected with said air entering pipe and said air flow meter is further separated to two sections, said sections are respectively combined with two ends of check valve; whereby, said check valve is utilized to prevent fluid from flowing back to said air flow meter and said air pump to cause damage.

9. The apparatus according to claim 8, wherein said high-pressure pump is electrically connected to an automatic controller; said automatic controller is further connected to a high-temperature protection switch; said high-temperature protection switch is combined with a connecting pipe between said high-pressure pump and said high-pressure groove; said automatic controller has a control element; whereby, said automatic controller is utilized to control the revolution time of said high-pressure pump, and when said automatic controller detects high-temperature message output from said high-temperature protection switch, said automatic controller controls said high-pressure pump to stop running and is revolved again after a preset time period.

10. The apparatus according to claim 9, wherein said automatic controller is further electrically connected to a hydraulic pressure switch; said hydraulic switch is combined with said output pipe; whereby, when said automatic controller detects low-pressure message output from said hydraulic pressure switch, then controls said high pressure pump to stop running and is revolved again after a preset time period.

11. The apparatus according to claim 10, wherein an inlet end of said output pipe extended into the inner part of said high-pressure groove is curved upward, and an opening of said inlet end faces upward and is close to a top end of said high-pressure groove; whereby, said tiny bubbles gathered at said top end of said high pressure groove are allowed to be more easily expelled.

12. The apparatus according to claim 11, wherein one of said high-pressure groove and said output pipe between said high-pressure groove and said throttle valve is combined with a thermometer; whereby, said thermometer is utilized to display temperature of fluid in said high-pressure groove.

13. The apparatus according to claim 12, further comprising a housing, said housing covering all components of said automatic controller except said control element.
